(19) United States
(12) Patent Application Publication
(10) Pub. No.: US 2019/0160564 A1
(43) Pub. Date: May 30, 2019

(54) CUTTING TOOLS AND TOOL HOLDERS FOR PIPE CUTTING FRAMES

(71) Applicant: Illinois Tool Works Inc., Glenview, IL (US)

(72) Inventor: Jeremy Edward Weinberg, Oak Park, IL (US)

(21) Appl. No.: 15/828,367

(22) Filed: Nov. 30, 2017

(51) Int. Cl. B23D 21/04; B23B 29/26; B23B 29/04

(52) U.S. Cl. CPC B23D 21/04; B23B 29/18; B23B 29/043; B23B 29/26

(57) ABSTRACT

Cutting tools and tool holders for pipe cutting frames are disclosed. Example cutting tools include a tool holder and a cutting insert removably securable in the tool holder. Example cutting inserts include: first and second side surfaces; first and second locating surfaces configured to locate the cutting insert in the tool holder between corresponding first and second clamping surfaces of the tool holder, wherein the first locating surface protrudes from the cutting insert with angled locating surfaces extending from the first locating surface to the first and second side surfaces, and the second locating surface comprising an indentation; front end and rear end surfaces; a rake surface, the rake surface and the front end surface forming a cutting edge; and an insert stop surface at a rear of the rake surface, extending from the rake surface to the first locating surface and the angled locating surfaces.

### BACKGROUND

This disclosure relates generally to orbital cutting and, more particularly, to cutting tools and tool holders for pipe cutting frames.

A variety of different types of pipe machining apparatuses exist to perform various machining processes on pipes, such as, for example, cutting pipes. One example of such pipe machining apparatuses includes a split frame pipe machining apparatus, which includes two or more frame members that surround the pipe from respective sides and couple together around the pipe. Such a pipe cutter includes a tool or cutting device that encircles the pipe and moves toward the pipe in small increments during the cutting process in order to slowly cut into the pipe. The tool is supported by a tool support. Eventually, after many small increments of adjustment toward the pipe, the pipe will be completely cut by the tool.

### SUMMARY

Cutting tools and tool holders for pipe cutting frames are disclosed, substantially as illustrated by and described in connection with at least one of the figures, as set forth more completely in the claims.

### BRIEF DESCRIPTION OF THE DRAWINGS

FIG. 1 is a perspective view of an example cutting tool including a tool holder and a cutting tip, in accordance with aspects of this disclosure.

FIG. 2 is a perspective view of the example implementation of the cutting tip of FIG. 1.

FIG. 3 is a side view of the example cutting tip of FIG. 2.

FIG. 4 is a rear view of the example cutting tip of FIG. 2.

FIG. 5 is a front view of the example cutting tip of FIG. 2.

FIG. 6 is a top view of the example cutting tip of FIG. 2.

FIG. 7 is a bottom view of the example cutting tip of FIG. 2.

FIG. 8 is a perspective view of another example implementation of the cutting tip of FIG. 1, including a groove in a rake surface.

FIG. 9 is a perspective view of the example tool holder of FIG. 1.

FIG. 10 is a side view of the example tool holder of FIG. 9.

FIG. 11 is a front view of the example tool holder of FIG. 9.

FIG. 12 is a top view of the example tool holder of FIG. 9.

FIG. 13 is more detailed side view of a clamping surface the example tool holder of FIG. 9.

FIG. 14 is a more detailed end view of a clamping surface of the example tool holder of FIG. 9.

FIG. 15 is a more detailed side view of the example cutting tip inserted into the tool holder of FIG. 1.

The figures are not necessarily to scale. Similar or identical reference numerals may be used to refer to similar or identical components.

### DETAILED DESCRIPTION

Conventional carbide parting inserts and holders are designed for production lathes and machining centers, and offer the ability to take advantage of higher cutting speeds and machine rigidity. Portable lathes, also known as split frames, do not offer the speed or rigidity to make the conventional carbide parting inserts or holders a practical solution. As a result, manufacturers of portable machine tools have offered solid high speed steel (HSS) parting tools with a single cutting edge. Constructing the entire tool out of the same HSS material results in unnecessarily expensive tools, and a large chunk of HSS that is not usable for parting when the cutting edge has worn out.

Disclosed example cutting tools use HSS parting inserts and/or carbide inserts. In some examples, the HSS or carbine parting inserts are constructed with a less wear-resistant grade than conventional carbides. However, the carbide grade used in disclosed example parting inserts is a superior solution over conventional carbide inserts when utilized on a portable cutting system, because disclosed example cutting tools use replaceable HSS inserts or carbine inserts that are substantially less expensive than conventional HSS or carbine parting tools. For example, when the cutting edge of an example HSS or carbine insert is worn, the insert can be discarded at substantially less cost. Additionally, use of the insert may permit faster replacement of a cutting edge when the cutting tool is installed in a portable machine tool, thereby reducing undesired downtime of the portable machine tool.

Disclosed example cutting inserts and tool holders enable the HSS and carbide inserts to be interchangeable. Some example tool holders have an interface seat into which the inserts are installed for cutting operations. The insert seat allows carbide and HSS inserts to be utilized in the same holder. In addition to inserts of different cutting materials, inserts of various sizes can also be installed, ranging from ¼ inch cutting width to approximately ⅜ inch in some examples, or even larger cutting widths. Example HSS inserts and carbide inserts include an insertion stop interface to prevent the HSS or carbide inserts from being pushed too far into the insert seat of the tool holder, which reduces or prevents damage to the tool holder.

While the following disclosure uses the terms “top,” “bottom,” “rear,” “front,” “left,” and/or “right,” these terms are relative to a reference view and are not necessarily absolute positions of the elements or views to which the terms reference. For example, disclosed examples do not necessarily require that a “top” surface of a cutting tip be positioned at the highest point of the cutting tip with respect to the earth.

Disclosed example cutting tools may be used to perform orbital cutting and/or other cutting, parting, or machining operations. For instance, disclosed cutting tools may be used in conjunction with pipe cutting or beveling systems.

Disclosed example cutting tools include a tool holder and a cutting insert removably securable in the tool holder. The cutting insert includes: first and second side surfaces; first and second locating surfaces configured to locate the cutting insert in the tool holder between corresponding first and second clamping surfaces of the tool holder, in which the first locating surface protrudes from the cutting insert with angled locating surfaces extending from the first locating surface to the first and second side surfaces, and the second locating surface includes an indentation; front end and rear end surfaces; a rake surface, in which the rake surface and the front end surface form a cutting edge; and an insert stop surface at a rear of the rake surface, extending from the rake surface to the first locating surface and the angled locating surfaces.

In some examples, the first clamping surface of the tool holder includes a groove configured to receive the protruding first location surface and the angled locating surfaces. In some examples, the second clamping surface of the tool holder includes a V-shaped protrusion configured to receive the second locating surface. In some examples, the indentation of the second locating surface comprises a V-shaped channel extending a length of the second locating surface.

In some example cutting tools, the cutting insert is at least one of high speed steel or carbide. In some examples, the tool holder includes a removal aperture configured to enable insertion and manipulation of a removal tool to remove the cutting insert from between the first and second clamping surfaces. In some examples, the insert stop surface is configured to contact an abutment surface of the tool holder when the cutting insert is fully inserted into the tool holder.

In some examples, the first and second clamping surfaces are on a first end of the tool holder, and the tool holder further includes third and fourth clamping surfaces on a second end of the tool holder opposite the first end. In some such examples, the third and fourth clamping surfaces are identical to the first and second clamping surfaces. In some examples, the third and fourth clamping surfaces are configured to accept a different cutting insert than the first and second clamping surfaces. In some example cutting tools, the second locating surface is longer than the first locating surface.

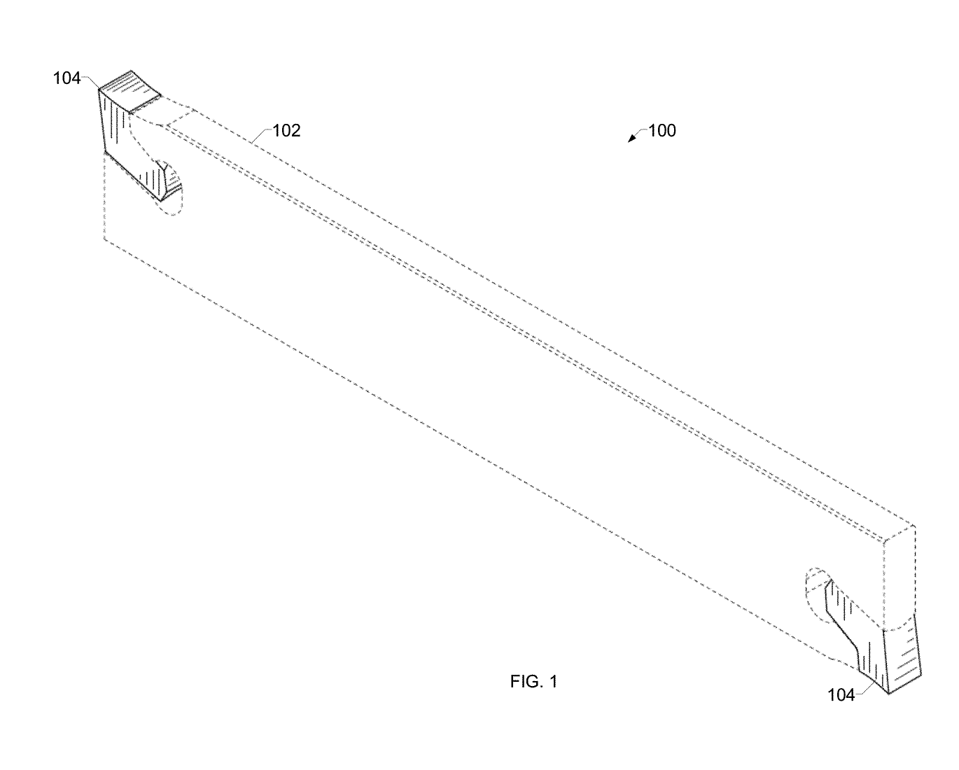

FIG. 1 is a perspective view of an example cutting tool 100 including a tool holder 102 and cutting tip 104. The tool holder 102 includes one or more apertures 106 into which the cutting tip 104 can be inserted and removed. The tool holder 102 may be used to attach the cutting tip 104 to a source of cutting power and/or one or more tools configured to position the cutting tip 104 against a workpiece.

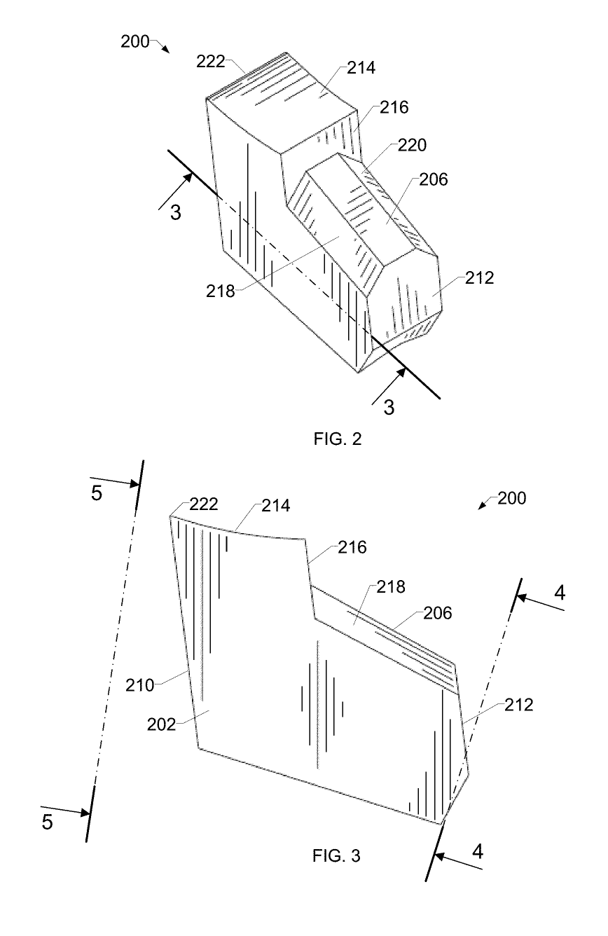

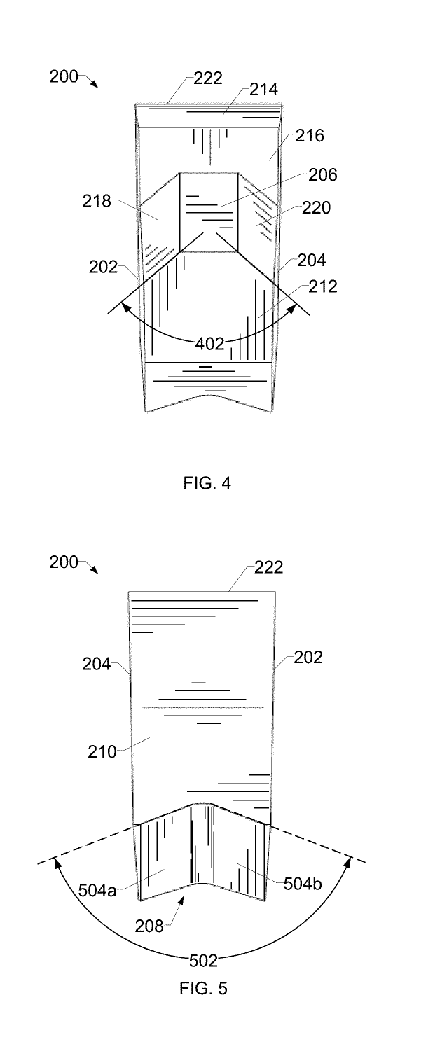

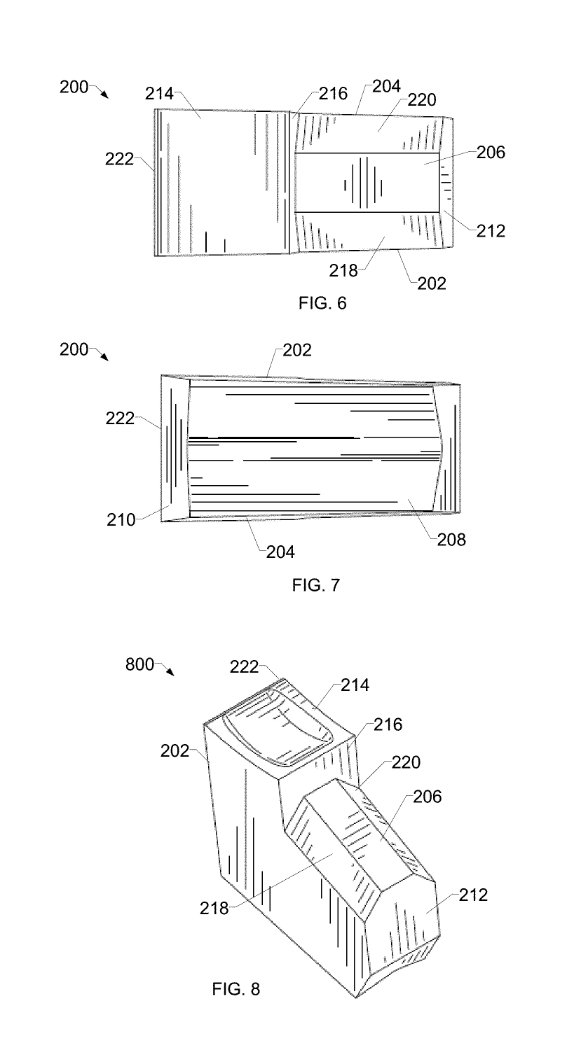

FIG. 2 is a perspective view of the example cutting insert 200 that may be used to implement the cutting tip 104 of FIG. 1. FIG. 3 is a side view of the example cutting insert 200, FIG. 4 is a rear view of the cutting insert 200, FIG. 5 is a front view of the cutting insert 200, FIG. 6 is a top view of the cutting insert 200, and FIG. 7 is a bottom view of the cutting insert 200.

The example cutting insert 200 is constructed (e.g., machined) from at least one of high speed steel or a carbide, such as tungsten carbide.

As illustrated in FIGS. 2-6, the example cutting insert 200 includes a first side surface 202, a second side surface 204, a top locating surface 206, a bottom locating surface 208, a front end surface 210, rear end surface(s) 212, a rake surface 214, and an insert stop surface 216. The example cutting insert 200 further includes angled locating surfaces 218, 220 extending from the top locating surface 206 to the first and second side surfaces 202, 204. In some examples, an angle 402 between the angled locating surfaces 218, 220 is 111°±10°. The front end surface 210 and the rake surface 214 form a cutting edge 222.

The top locating surface 206 protrudes from the cutting insert 200, while the bottom locating surface 208 forms an indentation. For example, the bottom locating surface 208 may be an indentation including angled locating surfaces 504a, 504b in the form of a V-shaped groove, extending a length of the cutting insert 200 (e.g., from the front end surface 210 toward the rear end surface(s) 212). The V-shaped groove may be rounded at the vertex of the groove. In some examples, an angle 502 between the angled locating surfaces 504a, 504b is 142°±10°.

The rear end surface(s) 212 of the illustrated example include two surfaces 212a, 212b. However, in other examples, more or fewer rear end surfaces may be used. For example, a single end surface may extend from the bottom locating surface 208 to the top locating surface 206 and the angled locating surfaces 218, 220. In other examples, additional end surfaces may be used (or a curved end surface may be used).

The insert stop surface 216 is at a rear of the rake surface 214, and extends from the rake surface 214 to the top locating surface 206 and the angled locating surfaces 218, 220. As discussed in more detail below, when the cutting insert 200 is inserted into the tool holder 102, the insert stop surface 216 strikes a corresponding surface on the tool holder 102 to position the cutting insert 200 at a correct location in the tool holder 102.

FIG. 8 is a perspective view of another example implementation of the cutting tip 104 of FIG. 1, including a groove in a rake surface. The example cutting insert 800 of FIG. 8 includes the first side surface 202, the second side surface 204, the top locating surface 206, the bottom locating surface 208, the front end surface 210, the rear end surface(s) 212, the rake surface 214, the insert stop surface 216, the angled locating surfaces 218, 220, and the cutting edge 222.

The example rake surface 214 illustrated in FIG. 8 includes a groove 802, which has a depth, width, and length that may be configured based on the type of cutting or parting. The groove 802 may assist with evacuation of chips from a workpiece during cutting or parting processes.

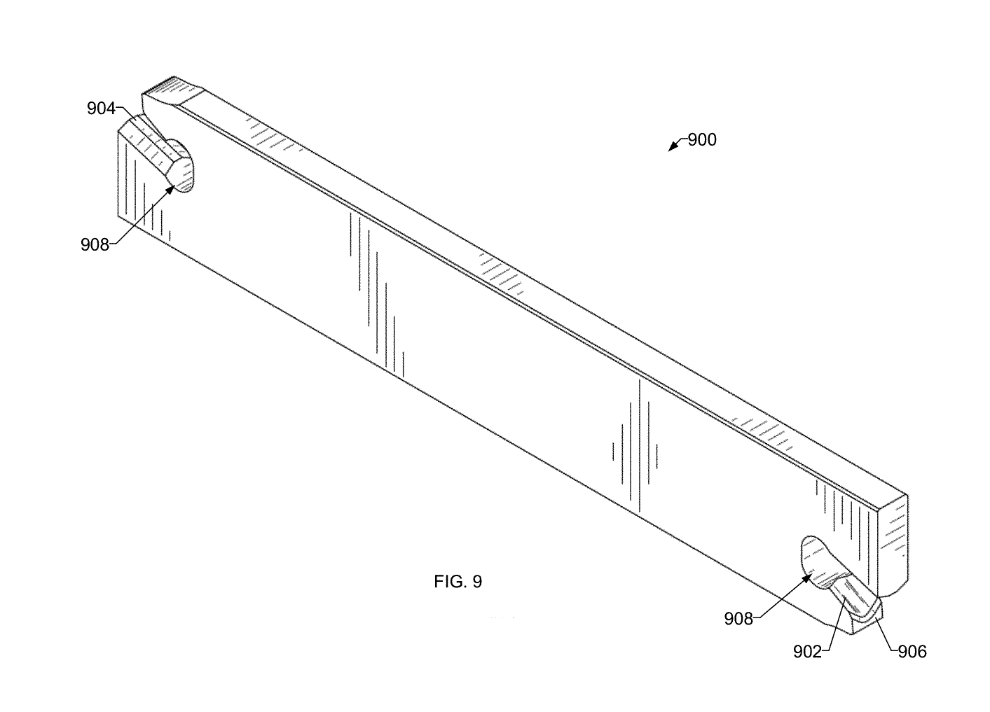

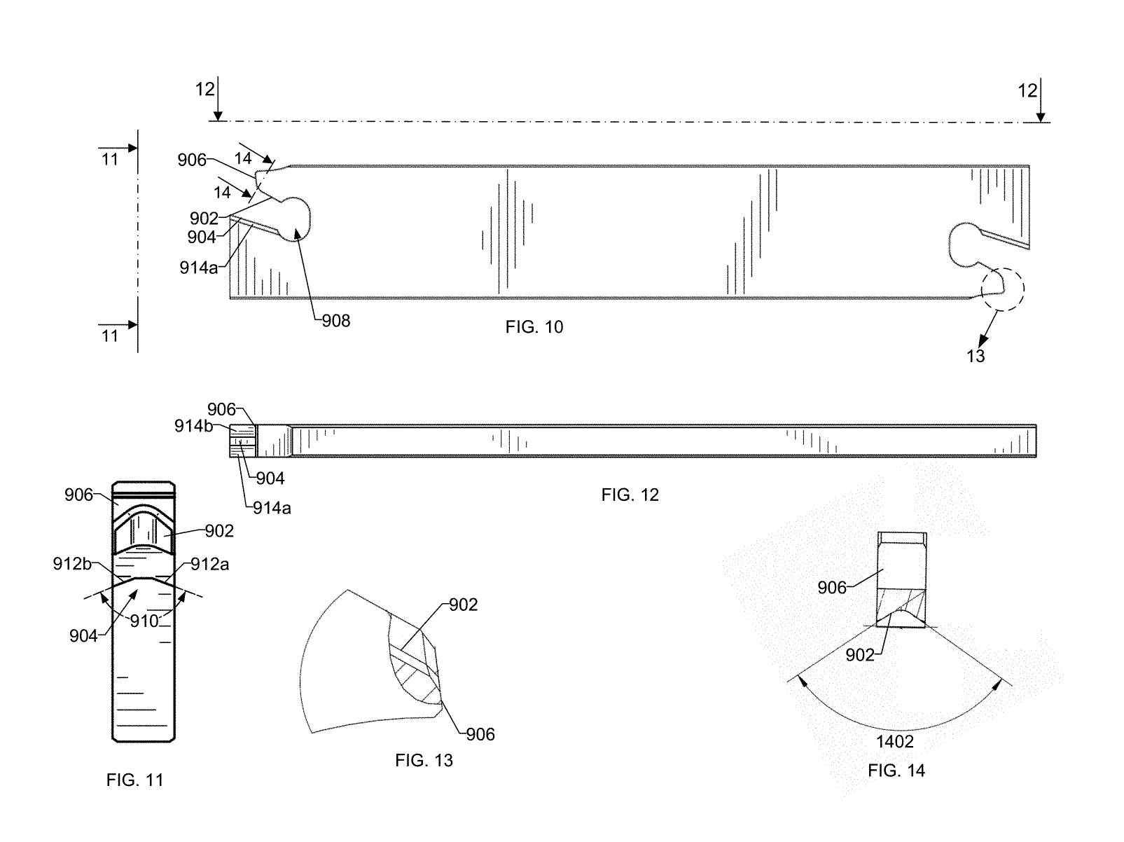

FIG. 9 is a perspective view of an example tool holder 900 that may be used to implement the tool holder 102 of FIG. 1. FIG. 10 is a side view of the tool holder 900. FIG. 11 is a front view of the tool holder 900. FIG. 12 is a top view of the tool holder 900. FIG. 13 is more detailed side view of a clamping surface of the tool holder 900, and FIG. 14 is a more detailed end view of a clamping surface of the tool holder 900.

In the illustrated example, the tool holder 900 includes a top clamping surface 902, a bottom clamping surface 904, an abutment surface 906, and a removal aperture 908. As illustrated in FIG. 9, the tool holder 900 may include multiple locations in which a cutting insert may be inserted into the tool holder 900. Each of the multiple locations includes a top clamping surface, a bottom clamping surface, an abutment surface, and a removal aperture. In some examples, the different locations on the tool holder may have differently sized top clamping surfaces, bottom clamping surfaces, abutment surfaces, and/or removal apertures to accommodate cutting tips of different sizes.

The top locating surface 206 and the bottom locating surface 208 locate the cutting insert 200 between the top clamping surface 902 and the bottom clamping surface 904 of the tool holder 900. The clamping surfaces 902, 904 are configured to apply a clamping force to the cutting insert 200 as the cutting insert 200 is inserted into the tool holder 900 (e.g., inserted between the clamping surfaces 902, 904).

As illustrated in FIG. 14, the top clamping surface 902 includes a V-shaped groove that receives the protrusion of the top locating surface 206 and contacts the angled locating surfaces 218, 220. The top clamping surface 902 may generally match and/or conform to the top locating surface 206 and the angled locating surfaces 218, 220 of the cutting insert 200. The vertex of the clamping surface 902 may be slightly rounded. In some examples, an angle 1402 between side clamping surfaces 1404a, 1404b is 111°±10° (e.g., similar or identical to the angle 402).

As illustrated in FIGS. 9 and 11, the bottom clamping surface 904 includes a V-shaped protrusion configured to receive the bottom locating surface 208. The example clamping surface 904 matches and/or conforms to the respective top and bottom locating surfaces 206, 208. In some examples, an angle 910 between side clamping surfaces 912a, 912b of the clamping surface 904 is 142°±10° (e.g., identical or similar to the angle 502). The example angles 402, 502, 910, 1402 are sufficiently obtuse and wide so as to spread out the support for the cutting insert 200 across the width of the tool holder 900.

The combination of protrusions and grooves in the locating surfaces 206, 208 and the clamping surfaces 902, 904 enable the cutting insert 200 to transfer torque loads on the cutting edge 222 resulting from cutting activities to the tool holder 900, thereby improving torque load capacity of the example cutting insert 200.

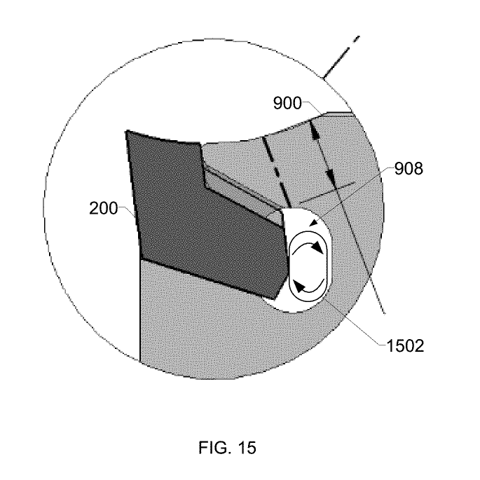

The removal aperture 908 enables a removal tool to be inserted into the aperture 908 and turned (or otherwise manipulated) to force the cutting insert 200 out of the tool holder 900. FIG. 15 is a more detailed side view of the example cutting insert 200 inserted into the tool holder 900. A cross-section of an example removal tool 1502 is illustrated in FIG. 15. When inserted into the aperture 908, twisting of the removal tool 1502 applies force to the rear surface(s) 212 of the cutting insert 200 and overcomes the clamping friction between the clamping surfaces 902, 904 and the locating surfaces 206, 208, 218, 220.

FIG. 15 also illustrates the substantial continuities between an end surface 1504 of the tool holder 900 and the front end surface 210 of the cutting insert 200, and between the rake surface 214 of the cutting insert 200 and a top surface 1506 of the tool holder 900.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A cutting tool, comprising:
a tool holder; and
a cutting insert removably securable in the tool holder, the cutting insert comprising:
first and second side surfaces;
first and second locating surfaces configured to locate the cutting insert in the tool holder between corresponding first and second clamping surfaces of the tool holder, wherein the first locating surface protrudes from the cutting insert with angled locating surfaces extending from the first locating surface to the first and second side surfaces, and the second locating surface comprising an indentation, wherein the angled locating surfaces form a first angle between 101 degrees and 121 degrees, and the second locating surface comprises angled surfaces forming a second angle between 132 degrees and 152 degrees;
front end and rear end surfaces;
a rake surface, the rake surface and the front end surface forming a cutting edge; and
an insert stop surface at a rear of the rake surface, extending from the rake surface to the first locating surface and the angled locating surfaces.

2. The cutting tool as defined in claim 1, wherein the first clamping surface of the tool holder comprises a groove configured to receive the protruding first location surface and the angled locating surfaces.

3. The cutting tool as defined in claim 1, wherein the second clamping surface of the tool holder comprises a V-shaped protrusion configured to receive the second locating surface.

4. The cutting tool as defined in claim 1, wherein the indentation of the second locating surface comprises a V-shaped channel extending a length of the second locating surface.

5. The cutting tool as defined in claim 1, wherein the cutting insert comprises at least one of high speed steel or carbide.

6. The cutting tool as defined in claim 1, wherein the tool holder comprises a removal aperture configured to enable insertion and manipulation of a removal tool to remove the cutting insert from between the first and second clamping surfaces.

7. The cutting tool as defined in claim 1, wherein the insert stop surface is configured to contact an abutment surface of the tool holder when the cutting insert is fully inserted into the tool holder.

8. The cutting tool as defined in claim 1, wherein the first and second clamping surfaces are on a first end of the tool holder, the tool holder further comprising third and fourth clamping surfaces on a second end of the tool holder opposite the first end.

9. The cutting tool as defined in claim 8, wherein the third and fourth clamping surfaces are identical to the first and second clamping surfaces.

10. The cutting tool as defined in claim 8, wherein the third and fourth clamping surfaces are configured to accept a different cutting insert than the first and second clamping surfaces.

11. The cutting tool as defined in claim 1, wherein the second locating surface is longer than the first locating surface.

12. The cutting tool as defined in claim 4, wherein the second locating surface is rounded at a vertex of the V-shaped channel.
